(19) United States
(12) Patent Application Publication
(10) Pub. No.: US 2023/0039328 A1
(43) Pub. Date: Feb. 9, 2023

(54) SELECTIVE USE OF TRANSMISSION DIVERSITY

(71) Applicant: QUALCOMM Incorporated, San Diego, CA (US)

(72) Inventors: Timo Ville VINTOLA, San Diego, CA (US); Sumant Jayaraman IYER, San Diego, CA (US); Masato KITAZOE, Tokyo (JP); Juan MONTOJO, San Diego, CA (US); Yi HUANG, San Diego, CA (US); Peter GAAL, San Diego, CA (US)

(21) Appl. No.: 17/657,034

(22) Filed: Mar. 29, 2022

Related U.S. Application Data
(60) Provisional application No. 63/260,018, filed on Aug. 6, 2021.

(51) Int. Cl. H04B 7/06; H04W 72/08

(52) U.S. Cl. CPC H04B 7/06; H04W 72/08

(57) ABSTRACT

Various aspects of the present disclosure generally relate to wireless communication. In some aspects, a user equipment (UE) may transmit an indication of support for selectively using transmission diversity for communicating. The UE may transmit one or more communications selectively using transmission diversity. Numerous other aspects are described.

### CROSS-REFERENCE TO RELATED APPLICATION

This Patent Application claims priority to U.S. Provisional Patent Application No. 63/260,018, filed on Aug. 6, 2021, entitled “SELECTIVE USE OF TRANSMISSION DIVERSITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for selective use of transmission diversity.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting an indication of support for selectively using transmission diversity for communicating. The method may include transmitting one or more communications selectively using transmission diversity.

Some aspects described herein relate to a method of wireless communication performed by a network node. The method may include receiving, from a UE, an indication of support for selectively using transmission diversity for communicating. The method may include receiving, from the UE, one or more communications selectively using transmission diversity.

Some aspects described herein relate to a UE for wireless communication. The user equipment may include a memory and one or more processors coupled to the memory. The one or more processors may be configured to transmit an indication of support for selectively using transmission diversity for communicating. The one or more processors may be configured to transmit one or more communications selectively using transmission diversity.

Some aspects described herein relate to a network node for wireless communication. The network node may include a memory and one or more processors coupled to the memory. The one or more processors may be configured to receive, from a UE, an indication of support for selectively using transmission diversity for communicating. The one or more processors may be configured to receive, from the UE, one or more communications selectively using transmission diversity.

Some aspects described herein relate to a non-transitory computer-readable medium that stores a set of instructions for wireless communication by a UE. The set of instructions, when executed by one or more processors of the UE, may cause the UE to transmit an indication of support for selectively using transmission diversity for communicating. The set of instructions, when executed by one or more processors of the UE, may cause the UE to transmit one or more communications selectively using transmission diversity.

Some aspects described herein relate to a non-transitory computer-readable medium that stores a set of instructions for wireless communication by a network node. The set of instructions, when executed by one or more processors of the network node, may cause the network node to receive, from a UE, an indication of support for selectively using transmission diversity for communicating. The set of instructions, when executed by one or more processors of the network node, may cause the network node to receive, from the UE, one or more communications selectively using transmission diversity.

Some aspects described herein relate to an apparatus for wireless communication. The apparatus may include means for transmitting an indication of support for selectively using transmission diversity for communicating. The apparatus may include means for transmitting one or more communications selectively using transmission diversity.

Some aspects described herein relate to an apparatus for wireless communication. The apparatus may include means for receiving, from a UE, an indication of support for selectively using transmission diversity for communicating. The apparatus may include means for receiving, from the UE, one or more communications selectively using transmission diversity.

Aspects generally include a method, apparatus, system, computer program product, non-transitory computer-readable medium, user equipment, network node, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of transmission diversity, in accordance with the present disclosure.

FIG. 4 is a diagram illustrating an example associated with selective use of transmission diversity, in accordance with the present disclosure.

FIGS. 5 and 6 are diagrams illustrating example processes associated with selective use of transmission diversity, in accordance with the present disclosure.

FIGS. 7 and 8 are diagrams of example apparatuses for wireless communication, in accordance with the present disclosure.

FIG. 9 is a diagram illustrating an example disaggregated base station architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

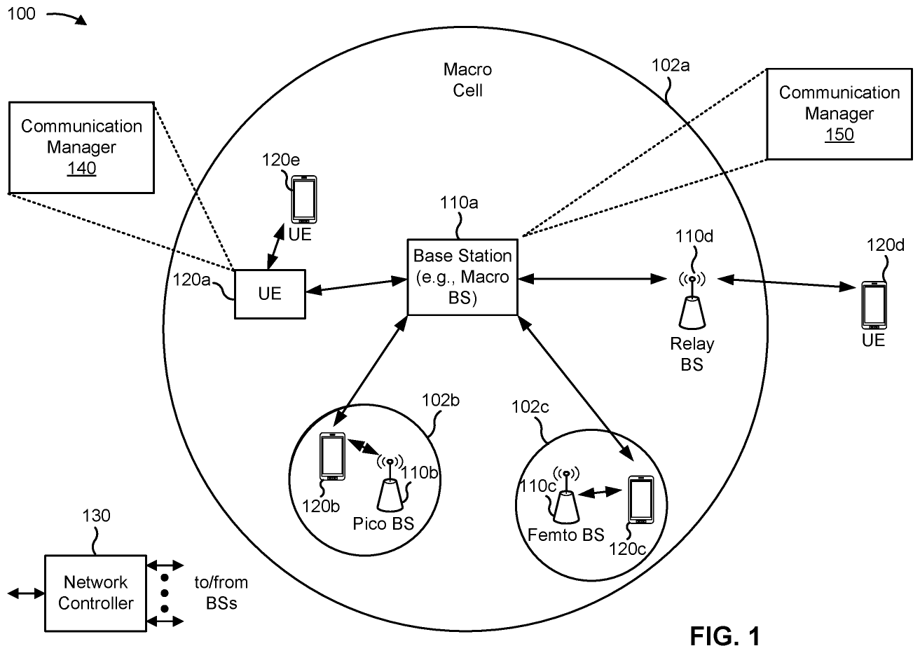

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may transmit an indication of support for selectively using transmission diversity for communicating; and transmit one or more communications selectively using transmission diversity. Additionally, or alternatively, the communication manager 140 may perform one or more other operations described herein.

In some aspects, a network node (e.g., the base station 110) may include a communication manager 150. As described in more detail elsewhere herein, the communication manager 150 may receive, from a UE, an indication of support for selectively using transmission diversity for communicating; and receive, from the UE, one or more communications selectively using transmission diversity. Additionally, or alternatively, the communication manager 150 may perform one or more other operations described herein.

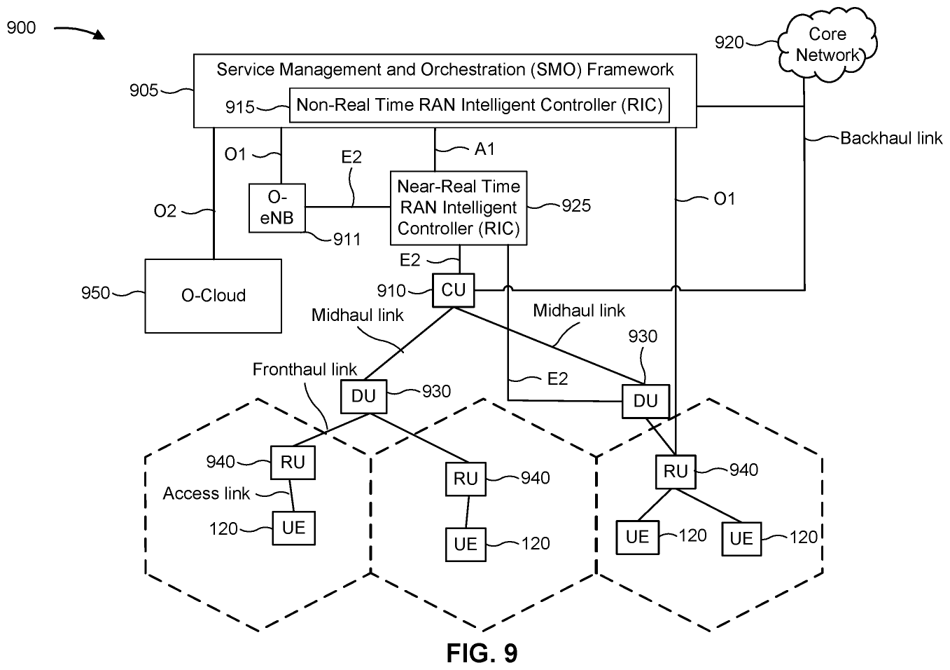

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

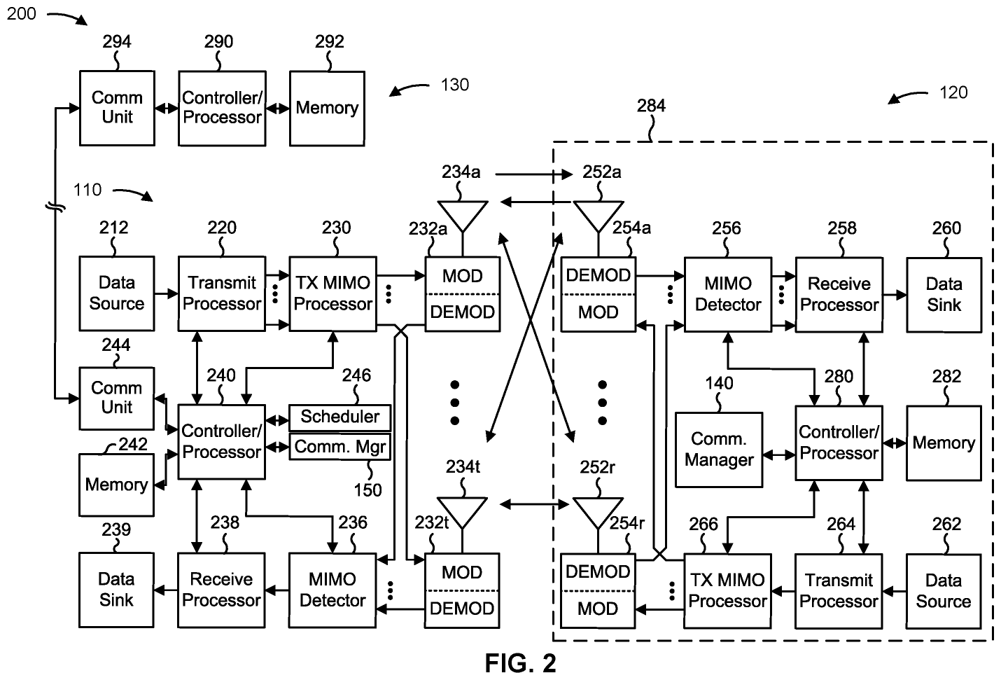

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

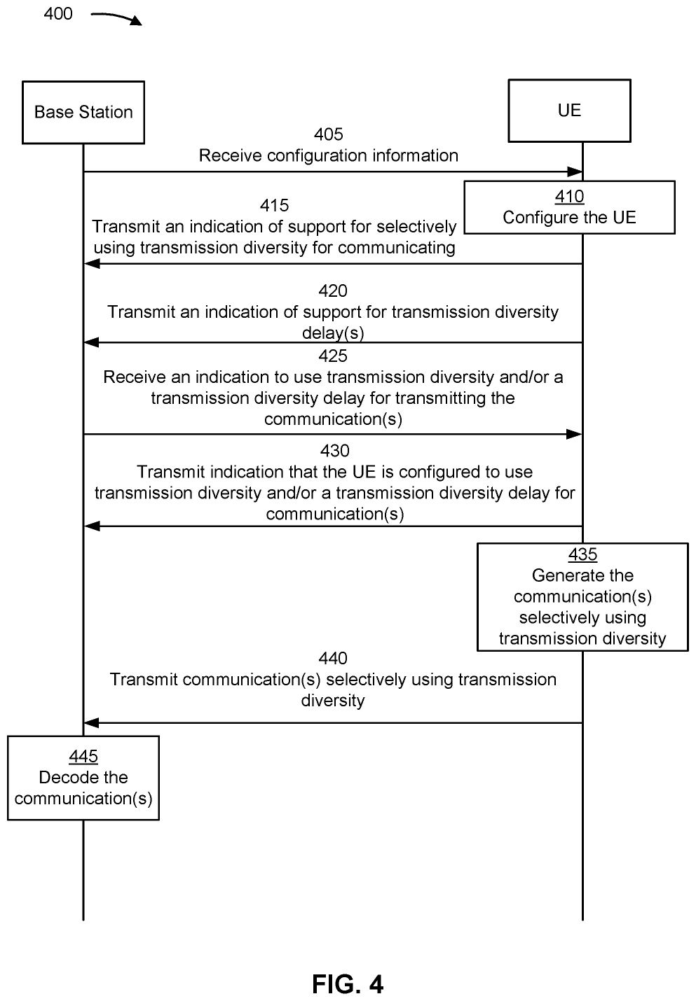

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-8).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-8).

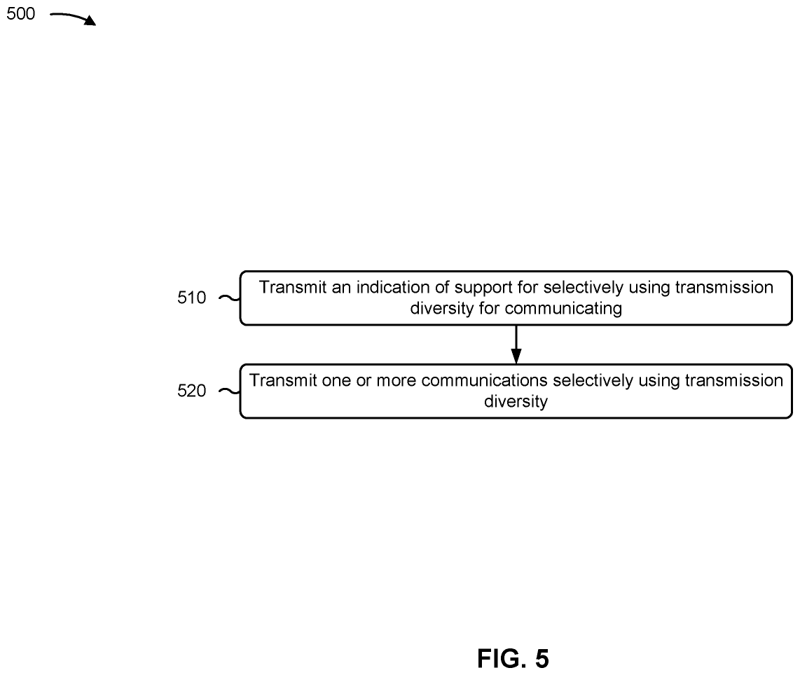

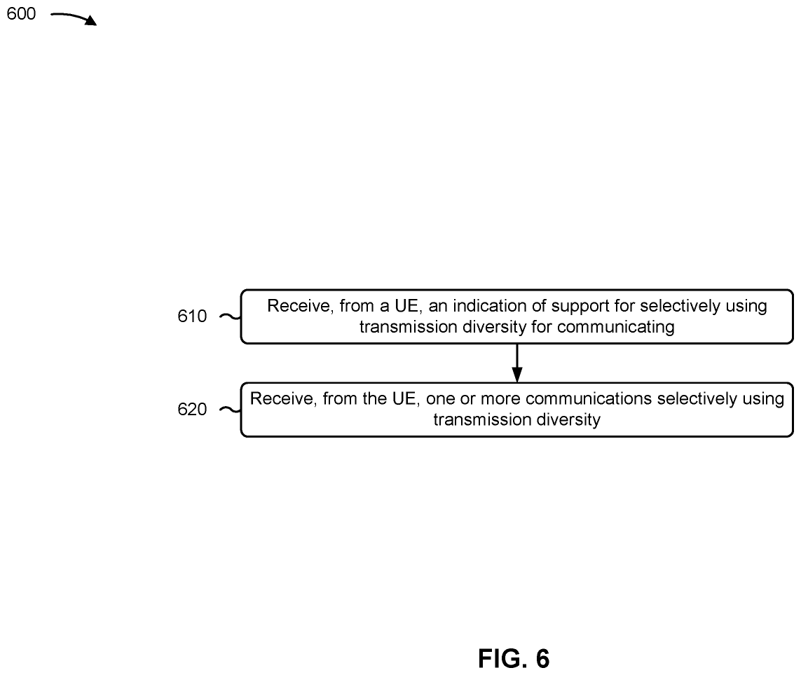

Controller/processor 240 of base station 110, controller/processor 280 of UE 120, and/or any other component(s) of FIG. 2 may perform one or more techniques associated with selective use of transmission diversity, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, the UE includes means for transmitting an indication of support for selectively using transmission diversity for communicating; and/or means for transmitting one or more communications selectively using transmission diversity. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for receiving, from a UE, an indication of support for selectively using transmission diversity for communicating; and/or means for receiving, from the UE, one or more communications selectively using transmission diversity. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

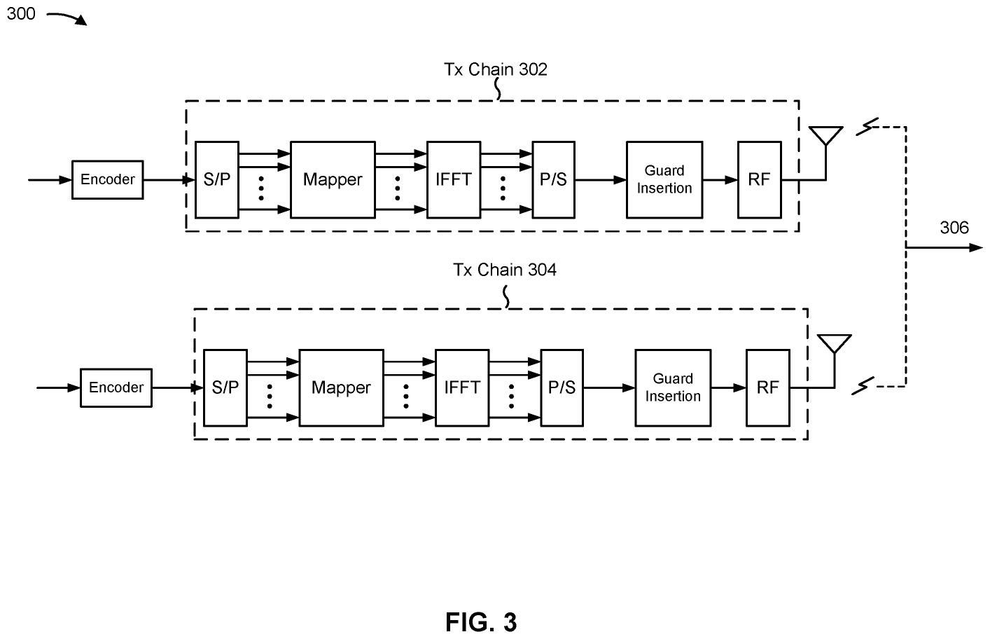

FIG. 3 is a diagram illustrating an example 300 of a transmission (Tx) chain 302 (also called a transmit chain) and a transmission chain 304 of a transmitting device (e.g., a UE or a base station), in accordance with the present disclosure. In some aspects, one or more components of transmission chain 302 and/or transmission chain 304 may be implemented in transmit processor 220, TX MIMO processor 230, modem 232, controller/processor 240, transmit processor 264, TX MIMO processor 266, modem 254, and/or controller/processor 280 as described above in connection with FIG. 2. In some aspects, transmission chain 302 and/or transmission chain 304 may be implemented in UE 120 for transmitting data (e.g., uplink data, an uplink reference signal, uplink control information (UCI), downlink data, a downlink reference signal, and/or downlink control information (DCI)) to a receiving device (e.g. a UE or a base station 110) on an uplink channel or a downlink channel.

An encoder may alter a signal (e.g., a bitstream) into data. Data to be transmitted is provided from encoder as input to a serial-to-parallel (S/P) converter. In some aspects, S/P converter may split the transmission data into N parallel data streams.

The N parallel data streams may then be provided as input to a mapper. Mapper may map the N parallel data streams onto N constellation points. The mapping may be done using a modulation constellation, such as binary phase-shift keying (BPSK), quadrature phase-shift keying (QPSK), 8 phase-shift keying (8PSK), quadrature amplitude modulation (QAM), etc. Thus, mapper may output N parallel symbol streams, each symbol stream corresponding to one of N orthogonal subcarriers of an inverse fast Fourier transform (IFFT) component. These N parallel symbol streams are represented in the frequency domain and may be converted into N parallel time domain sample streams by an IFFT component.

The N parallel time domain sample streams may be converted into an OFDM/OFDMA symbol stream by a parallel-to-serial (P/S) converter. A guard insertion component may insert a guard interval between successive OFDM/OFDMA symbols in the OFDM/OFDMA symbol stream. The output of guard insertion component may then be upconverted to a desired transmit frequency band by a radio frequency (RF) front end.

The RF front end includes a power amplifier that is used to control a power of transmission of a resulting signal 306 via an antenna. In some examples, the transmitting device may be configured to transmit the resulting signal 306 with a desired total power. If the power amplifier of a single transmission chain has a capability to transmit the resulting signal 306 with the desired total power, the transmitting device may transmit the resulting signal 306 using a single transmission chain (e.g., transmission chain 302 or transmission chain 304) and/or a single antenna. If the power amplifier of a single transmission chain does not have a capability to transmit the resulting signal 306 with the desired total power, the transmitting device may transmit the resulting signal 306 using multiple transmission chains (e.g., transmission chain 302 and transmission chain 304) and/or a multiple antennas. Transmitting the resulting signal 306 using multiple transmission chains may be referred to as using transmission diversity.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally, or alternatively, a set of components (e.g., one or more components) shown in FIG. 3 may perform one or more functions described as being performed by another set of components shown in FIG. 3.

In some networks, a transmitting device may be capable of transmitting a signal with a desired power using a single transmit chain (e.g., using a single power amplifier) or using transmission diversity (e.g., using multiple power amplifiers). Transmitting using a single transmit chain provides some benefits (e.g., improved power efficiency, improved coherency of a single signal source, among other examples) while transmitting using transmission diversity provides other benefits (e.g., signal source diversity may improve a likelihood of the signal reaching a receiving device, signal source diversity may permit the transmitting device to adjust for a maximum permissible exposure event, delay techniques may improve throughput, among other examples). However, a receiving device may consume computing resources to attempt to process and/or decode the signal using different hypotheses associated with whether transmission diversity was used to transmit the signal and/or what parameters were used for the transmission diversity, if used. Additionally, if the receiving device is unable to decode the signal based at least in part on attempting to process and/or decode the signal using the different hypotheses, the receiving device and/or the transmitting device may consume network, communication, power, and/or computing resources to recover from failure to decode the signal.

In some aspects described herein, a transmitting device (e.g., a UE or a base station) may transmit an indication of support for using transmission diversity for communicating and also support for not using transmission diversity for communicating (e.g., using a single transmission chain and/or a single power amplifier, among other examples). In some aspects, a UE may transmit an indication that the UE supports no transmission diversity, must use transmission diversity to achieve a desired power, or is capable of using either a single transmit chain or transmission diversity to achieve the desired power. In some aspects, the UE support may be based at least in part on components of the UE, such as a maximum power of one or more power amplifiers used for transmissions.

In some aspects, the UE may receive an indication from a network node (e.g., a base station) that indicates whether to use transmission diversity. Alternatively, the UE may transmit an indication that the UE is configured to use transmission diversity (e.g., that the UE will use transmission diversity). Additionally, or alternatively, the UE may transmit a request and/or a recommendation for the UE to use transmission diversity or not to use transmission diversity for one or more communications. Based at least in part on communicating whether the UE is to use transmission diversity, the network node may improve decoding and/or reduce a likelihood of a communication error that may have otherwise been caused by a failure to decode a communication from the UE. In this way, the UE and/or the network node may conserve network, communication, power, and/or computing resources that may have otherwise been used to recover from a failure to decode an uplink transmission.

In some aspects, the UE may indicate support for one or more types of transmission diversity delays, such as zero-delay transmission diversity, linear delay transmission diversity, or cyclic delay transmission diversity. Additionally, or alternatively, the UE may indicate in amount of the transmission diversity delays and/or whether the UE supports a constant transmission diversity delay, a variable transmission diversity delay, and/or whether the transmission delays are associated with (e.g., mapped to) an allocation, a bandwidth part, and/or a channel bandwidth size. In some aspects, the UE may indicate that the UE supports different transmission delays for different allocations, different bandwidth parts, and/or different channel bandwidth sizes. The network node may transmit an indication of a transmission diversity delay for the UE to use, the UE may transmit an indication of a transmission diversity delay that the UE will use, and/or the UE may transmit an indication of a request and/or a recommendation for a transmission diversity delay to use for one or more communications, among other examples. In this way, the UE and/or the network node may communicate with improved throughput and/or may conserve network, communication, power, and/or computing resources that may have otherwise been used to recover from a failure to decode an uplink transmission based at least in part on the network node being unaware of a transmission diversity delay associated with the one or more communications. For example, based at least in part on communicating the transmission diversity delay, the network node may use improved hypothesis for de-rotating symbols for cyclic delay transmission diversity and/or linearly shifting symbols for linear delay transmission diversity. Communicating the transmission diversity delay may also improve beam forming and/or beam selection.

FIG. 4 is a diagram illustrating an example 400 associated with selective use of transmission diversity, in accordance with the present disclosure. As shown in FIG. 4, a network node (e.g., base station 110) may communicate with a UE (e.g., UE 120). In some aspects, the network node and the UE may be part of a wireless network (e.g., wireless network 100). The UE and the network node may have established a wireless connection prior to operations shown in FIG. 4.

As shown by reference number 405, the network node may transmit, and the UE may receive, configuration information. In some aspects, the UE may receive the configuration information via one or more of radio resource control (RRC) signaling, medium access control (MAC) control elements (MAC CEs), and/or downlink control information (DCI), among other examples. In some aspects, the configuration information may include an indication of one or more configuration parameters (e.g., already known to the UE) for selection by the UE, and/or explicit configuration information for the UE to use to configure the UE, among other examples.

In some aspects, the configuration information may indicate that the UE is to transmit an indication of support for selectively using transmission diversity for communicating with the network node. In some aspects, the configuration information may indicate that the UE is to transmit an indication of one or more types of supported transmission diversity delay. In some aspects, the configuration information may indicate that the UE is to transmit an indication of whether transmission diversity is used for one or more communications, transmit an indication of a request and/or a recommendation for using transmission diversity, and/or receive an indication that the UE is to use transmission diversity. In some aspects, the configuration information may indicate that the UE is to transmit an indication of a type of transmission diversity delay that is used for one or more communications, transmit an indication of a request and/or a recommendation a type of transmission diversity delay to use, and/or receive an indication that the UE is to use a type of transmission diversity delay.

As shown by reference number 410, the UE may configure the UE based at least in part on the configuration information. In some aspects, the UE may be configured to perform one or more operations described herein based at least in part on the configuration information.

As shown by reference number 415, the UE may transmit, and the network node may receive, an indication of support for selectively using transmission diversity for communicating with the network node. In some aspects, the UE may transmit the indication of support via RRC signaling (e.g., as part of an RRC connection process).

In some aspects, the indication of support for selectively using transmission diversity for communicating includes an indication of support for selectively using a single transmission chain for communicating. For example, the indication may include an indication that the UE is capable of using transmission diversity or using a single transmission chain for communicating with the network node (e.g., based at least in part on components, such as power amplifiers, of the UE). In some aspects, the indication of support for selectively using transmission diversity for communicating indicates that the UE is capable of providing a threshold power amplification via a single power amplifier and is capable of providing the threshold power amplification via multiple power amplifiers using transmission diversity.

As shown by reference number 420, the UE may transmit, and the network node may receive, an indication of support for one or more transmission diversity delays. For example, the UE may transmit an indication of support for zero-delay transmission diversity, linear delay transmission diversity, and/or cyclic delay transmission diversity. Additionally, or alternatively, the UE may transmit an indication of whether the UE supports transmission diversity delay that is a constant delay, and/or whether the UE supports transmission diversity delay that is a variable delay. In some aspects, the UE may transmit an indication of one or more parameters for transmission diversity (e.g., statically configured for transmission diversity or adjustable for transmission diversity). The parameters may include, for example, a mapping of one or more indicated transmission diversity delays to one or more allocations, a mapping of one or more indicated transmission diversity delays to one or more bandwidth parts, and/or a mapping of one or more indicated transmission diversity delays to one or more channel bandwidth sizes, among other examples.

As shown by reference number 425, the UE may receive, and the network node may transmit, an indication to use transmission diversity and/or an indication of a transmission diversity delay for transmitting one or more communications. In some aspects, the network node may transmit in the indication within a resource grant (e.g., via DCI, MAC CE, or RRC signaling). In some aspects, the network node may transmit the indication within a communication (e.g., using DCI MAC CE, or RRC signaling) that is separate from a resource grant.

In some aspects, the network node may indicate to use a transmission delay, of the one or more transmission diversity delays supported by the UE, to transmit the one or more communications. for example, the network node may indicate to use a transmission diversity delay that is a constant delay, or a transmission diversity delay that is a variable delay. Additionally, or alternatively, the network node may transmit an indication of one or more parameters for using transmission diversity delay, such as a mapping of one or more indicated transmission diversity delays to one or more allocations, a mapping of one or more indicated transmission diversity delays to one or more bandwidth parts, and/or a mapping of one or more indicated transmission diversity delays to one or more channel bandwidth sizes. In some aspects, the network node may allocate resources associated with a bandwidth part or a bandwidth size based at least in part on an indication of UE support for the one or more transmission diversity delays when using the bandwidth part or the bandwidth size.

As shown by reference number 430, the UE may transmit an indication that the UE is configured to use transmission diversity and/or an indication of a transmission diversity delay for the one or more communications. For example, the UE may transmit the indication via RRC signaling, MAC CE signaling, or uplink control information (UCI) signaling.

As shown by reference number 435, the UE may generate the one or more communications selectively using transmission diversity. For example, the UE may apply transmission diversity and/or a transmission diversity delay based at least in part receiving one or more indications described in connection with reference number 425 and/or based at least in part on transmitting one or more indication described in connection with reference number 430. In some aspects, the UE may apply transmission diversity and/or a transmission diversity delay for a number of transmissions, for an amount of time, and/or until signaling that indicates a change. In some aspects, the number of transmission and/or the amount of time may be configured (e.g., based at least in part on the configuration information and/or a communication protocol) and/or may be indicated (e.g., based at least in part on one or more indication described in connection with reference number 425 and/or based at least in part on one or more indication described in connection with reference number 430).

As shown by reference number 440, the UE may transmit, and the network node may receive, the one or more communications selectively using transmission diversity. For example, the UE may apply transmission diversity and/or a transmission diversity delay to a first subset of the one or more communications and/or may use a single transmission chain for transmitting a second subset of the one or more communications.

As shown by reference number 445, the network node may decode the one or more communications based at least in part on an awareness of whether the UE applied transmission diversity and/or a transmission diversity delay to the one or more communications. For example, the network node may estimate a channel, may de-rotate symbols, and/or may linearly shift symbols based at least in part on the awareness of whether the UE applied transmission diversity and/or a transmission diversity delay to the one or more communications.

Based at least in part on communicating whether the UE is to use transmission diversity, the network node may improve decoding and/or reduce a likelihood of a communication error that may have otherwise been caused by a failure to decode a communication from the UE. In this way, the UE and/or the network node may conserve network, communication, power, and/or computing resources that may have otherwise been used to recover from a failure to decode an uplink transmission. Based at least in part on the network node and the UE communicating a transmission diversity delay, the UE and/or the network node may communicate with improved throughput and/or may conserve network, communication, power, and/or computing resources that may have otherwise been used to recover from a failure to decode an uplink transmission based at least in part on the network node being unaware of a transmission diversity delay associated with the one or more communications.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with selective use of transmission diversity.

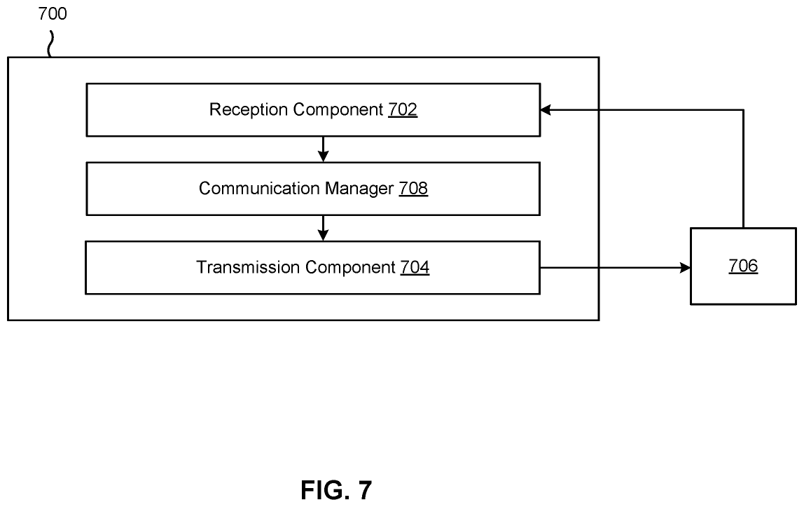

As shown in FIG. 5, in some aspects, process 500 may include transmitting an indication of support for selectively using transmission diversity for communicating (block 510). For example, the UE (e.g., using communication manager 140 and/or transmission component 704, depicted in FIG. 7) may transmit an indication of support for selectively using transmission diversity for communicating, as described above.

As further shown in FIG. 5, in some aspects, process 500 may include transmitting one or more communications selectively using transmission diversity (block 520). For example, the UE (e.g., using communication manager 140 and/or transmission component 704, depicted in FIG. 7) may transmit one or more communications selectively using transmission diversity, as described above.

Process 500 may include additional aspects, such as any single aspect or any combination of aspects described below and/or in connection with one or more other processes described elsewhere herein.

In a first aspect, process 500 includes receiving an indication to use transmission diversity for transmitting the one or more communications.

In a second aspect, alone or in combination with the first aspect, process 500 includes transmitting an indication that the UE is configured to transmit the one or more communications using transmission diversity.

In a third aspect, alone or in combination with one or more of the first and second aspects, the indication of support for selectively using transmission diversity for communicating includes an indication of support for selectively using a single transmission chain for communicating.

In a fourth aspect, alone or in combination with one or more of the first through third aspects, transmitting the one or more communications selectively using transmission diversity comprises transmitting a first subset of the one or more communications using transmission diversity, and transmitting a second subset of the one or more communications using a single transmission chain.

In a fifth aspect, alone or in combination with one or more of the first through fourth aspects, the indication of support for selectively using transmission diversity for communicating indicates that the UE is capable of providing a threshold power amplification via a single power amplifier and is capable of providing the threshold power amplification via multiple power amplifiers using transmission diversity.

In a sixth aspect, alone or in combination with one or more of the first through fifth aspects, process 500 includes transmitting an indication of support for one or more of zero-delay transmission diversity, linear delay transmission diversity, or cyclic delay transmission diversity.

In a seventh aspect, alone or in combination with one or more of the first through sixth aspects, process 500 includes transmitting an indication of one or more of whether the UE supports transmission diversity delay that is a constant delay, or whether the UE supports transmission diversity delay that is a variable delay.

In an eighth aspect, alone or in combination with one or more of the first through seventh aspects, process 500 includes transmitting an indication of one or more parameters of using transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

In a ninth aspect, alone or in combination with one or more of the first through eighth aspects, process 500 includes receiving an indication to use, for the one or more communications, one or more of a transmission diversity delay that is a constant delay, or a transmission diversity delay that is a variable delay.

In a tenth aspect, alone or in combination with one or more of the first through ninth aspects, process 500 includes receiving an indication of one or more parameters for using a transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a network node, in accordance with the present disclosure. Example process 600 is an example where the network node (e.g., base station 110) performs operations associated with selective use of transmission diversity.

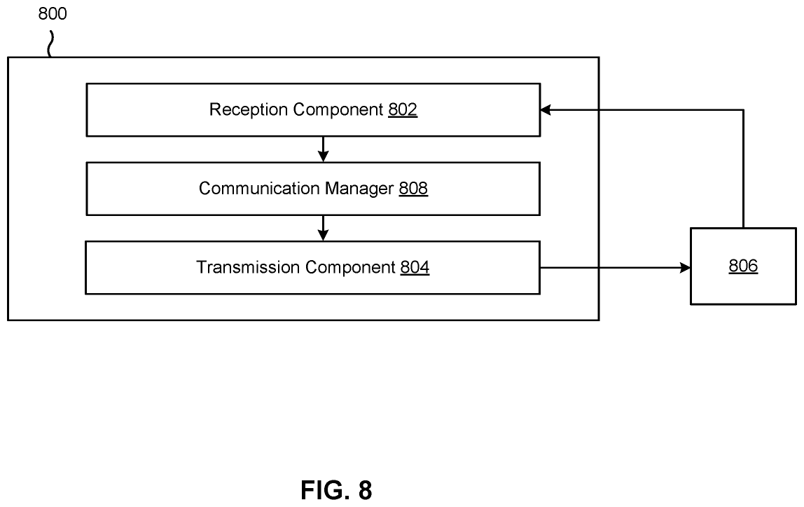

As shown in FIG. 6, in some aspects, process 600 may include receiving, from a UE, an indication of support for selectively using transmission diversity for communicating (block 610). For example, the network node (e.g., using communication manager 150 and/or reception component 802, depicted in FIG. 8) may receive, from a UE, an indication of support for selectively using transmission diversity for communicating, as described above.

As further shown in FIG. 6, in some aspects, process 600 may include receiving, from the UE, one or more communications selectively using transmission diversity (block 620). For example, the network node (e.g., using communication manager 150 and/or reception component 802, depicted in FIG. 8) may receive, from the UE, one or more communications selectively using transmission diversity, as described above.

Process 600 may include additional aspects, such as any single aspect or any combination of aspects described below and/or in connection with one or more other processes described elsewhere herein.

In a first aspect, process 600 includes transmitting an indication to use transmission diversity for transmitting the one or more communications.

In a second aspect, alone or in combination with the first aspect, process 600 includes receiving an indication that the UE is configured to transmit the one or more communications using transmission diversity.

In a third aspect, alone or in combination with one or more of the first and second aspects, the indication of support for selectively using transmission diversity for communicating includes an indication of support for selectively using a single transmission chain for communicating.

In a fourth aspect, alone or in combination with one or more of the first through third aspects, receiving the one or more communications selectively using transmission diversity comprises receiving a first subset of the one or more communications using transmission diversity, and receiving a second subset of the one or more communications using a single transmission chain.

In a fifth aspect, alone or in combination with one or more of the first through fourth aspects, the indication of support for selectively using transmission diversity for communicating indicates that the UE is capable of providing a threshold power amplification via a single power amplifier and is capable of providing the threshold power amplification via multiple power amplifiers using transmission diversity.

In a sixth aspect, alone or in combination with one or more of the first through fifth aspects, process 600 includes receiving an indication of support for one or more of zero-delay transmission diversity, linear delay transmission diversity, or cyclic delay transmission diversity.

In a seventh aspect, alone or in combination with one or more of the first through sixth aspects, process 600 includes receiving an indication of one or more of whether the UE supports transmission diversity delay that is a constant delay, or whether the UE supports transmission diversity delay that is a variable delay.

In an eighth aspect, alone or in combination with one or more of the first through seventh aspects, process 600 includes receiving an indication of one or more parameters of using transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

In a ninth aspect, alone or in combination with one or more of the first through eighth aspects, process 600 includes transmitting an indication to use, for the one or more communications, one or more of a transmission diversity delay that is a constant delay, or a transmission diversity delay that is a variable delay.

In a tenth aspect, alone or in combination with one or more of the first through ninth aspects, process 600 includes transmitting an indication of one or more parameters for using a transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708 (e.g., the communication manager 140).

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The transmission component 704 may transmit an indication of support for selectively using transmission diversity for communicating. The transmission component 704 may transmit one or more communications selectively using transmission diversity.

The reception component 702 may receive an indication to use transmission diversity for transmitting the one or more communications.

The transmission component 704 may transmit an indication that the UE is configured to transmit the one or more communications using transmission diversity.

The transmission component 704 may transmit an indication of support for one or more of zero-delay transmission diversity, linear delay transmission diversity, or cyclic delay transmission diversity.

The transmission component 704 may transmit an indication of one or more of whether the UE supports transmission diversity delay that is a constant delay, or whether the UE supports transmission diversity delay that is a variable delay.

The transmission component 704 may transmit an indication of one or more parameters of using transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

The reception component 702 may receive an indication to use, for the one or more communications, one or more of a transmission diversity delay that is a constant delay, or a transmission diversity delay that is a variable delay.

The reception component 702 may receive an indication of one or more parameters for using a transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node (e.g., a base station), or a network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808 (e.g., the communication manager 150).

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The reception component 802 may receive, from a UE, an indication of support for selectively using transmission diversity for communicating. The reception component 802 may receive, from the UE, one or more communications selectively using transmission diversity.

The transmission component 804 may transmit an indication to use transmission diversity for transmitting the one or more communications.

The reception component 802 may receive an indication that the UE is configured to transmit the one or more communications using transmission diversity.

The reception component 802 may receive an indication of support for one or more of zero-delay transmission diversity, linear delay transmission diversity, or cyclic delay transmission diversity.

The reception component 802 may receive an indication of one or more of whether the UE supports transmission diversity delay that is a constant delay, or whether the UE supports transmission diversity delay that is a variable delay.

The reception component 802 may receive an indication of one or more parameters of using transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

The transmission component 804 may transmit an indication to use, for the one or more communications, one or more of a transmission diversity delay that is a constant delay, or a transmission diversity delay that is a variable delay.

The transmission component 804 may transmit an indication of one or more parameters for using a transmission diversity delay, the one or more parameters comprising one or more of a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram illustrating an example 900 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 9 may include one or more CUs 910 that can communicate directly with a core network 920 via a backhaul link, or indirectly with the core network 920 through one or more disaggregated base station units (such as a Near-Real Time (Near-RT) RAN Intelligent Controller (MC) 925 via an E2 link, or a Non-Real Time (Non-RT) RIC 915 associated with a Service Management and Orchestration (SMO) Framework 905, or both). A CU 910 may communicate with one or more DUs 930 via respective midhaul links, such as an F1 interface. The DUs 930 may communicate with one or more RUs 940 via respective fronthaul links. The RUs 940 may communicate with respective UEs 120 via one or more radio frequency (RF) access links. In some implementations, the UE 120 may be simultaneously served by multiple RUs 940.

Each of the units (e.g., the CUs 910, the DUs 930, the RUs 940), as well as the Near-RT RICs 925, the Non-RT RICs 915, and the SMO Framework 905, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 910 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 910. The CU 910 may be configured to handle user plane functionality (e.g., Central Unit-User Plane (CU-UP)), control plane functionality (e.g., Central Unit-Control Plane (CU-CP)), or a combination thereof. In some implementations, the CU 910 can be logically split into one or more CU-UP units and one or more CU-CP units. The CU-UP unit can communicate bidirectionally with the CU-CP unit via an interface, such as the El interface when implemented in an O-RAN configuration. The CU 910 can be implemented to communicate with the DU 930, as necessary, for network control and signaling.

The DU 930 may correspond to a logical unit that includes one or more base station functions to control the operation of one or more RUs 940. In some aspects, the DU 930 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 930 may further host one or more low-PHY layers. Each layer (or module) can be implemented with an interface configured to communicate signals with other layers (and modules) hosted by the DU 930, or with the control functions hosted by the CU 910.

Lower-layer functionality can be implemented by one or more RUs 940. In some deployments, an RU 940, controlled by a DU 930, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 940 can be implemented to handle over the air (OTA) communication with one or more UEs 120. In some implementations, real-time and non-real-time aspects of control and user plane communication with the RU(s) 940 can be controlled by the corresponding DU 930. In some scenarios, this configuration can enable the DU(s) 930 and the CU 910 to be implemented in a cloud-based RAN architecture, such as a vRAN architecture.

The SMO Framework 905 may be configured to support RAN deployment and provisioning of non-virtualized and virtualized network elements. For non-virtualized network elements, the SMO Framework 905 may be configured to support the deployment of dedicated physical resources for RAN coverage requirements which may be managed via an operations and maintenance interface (such as an O1 interface). For virtualized network elements, the SMO Framework 905 may be configured to interact with a cloud computing platform (such as an open cloud (O-Cloud) 990) to perform network element life cycle management (such as to instantiate virtualized network elements) via a cloud computing platform interface (such as an O2 interface). Such virtualized network elements can include, but are not limited to, CUs 910, DUs 930, RUs 940 and Near-RT RICs 925. In some implementations, the SMO Framework 905 can communicate with a hardware aspect of a 4G RAN, such as an open eNB (O-eNB) 911, via an O1 interface. Additionally, in some implementations, the SMO Framework 905 can communicate directly with one or more RUs 940 via an O1 interface. The SMO Framework 905 also may include a Non-RT RIC 915 configured to support functionality of the SMO Framework 905.

The Non-RT RIC 915 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 925. The Non-RT RIC 915 may be coupled to or communicate with (such as via an A1 interface) the Near-RT RIC 925. The Near-RT RIC 925 may be configured to include a logical function that enables near-real-time control and optimization of RAN elements and resources via data collection and actions over an interface (such as via an E2 interface) connecting one or more CUs 910, one or more DUs 930, or both, as well as an O-eNB, with the Near-RT RIC 925.

In some implementations, to generate AI/ML models to be deployed in the Near-RT RIC 925, the Non-RT RIC 915 may receive parameters or external enrichment information from external servers. Such information may be utilized by the Near-RT RIC 925 and may be received at the SMO Framework 905 or the Non-RT RIC 915 from non-network data sources or from network functions. In some examples, the Non-RT RIC 915 or the Near-RT RIC 925 may be configured to tune RAN behavior or performance. For example, the Non-RT RIC 915 may monitor long-term trends and patterns for performance and employ AI/ML models to perform corrective actions through the SMO Framework 905 (such as reconfiguration via O1) or via creation of RAN management policies (such as A1 policies).

As indicated above, FIG. 9 is provided as an example. Other examples may differ from what is described with regard to FIG. 9.

The following provides an overview of some Aspects of the present disclosure:

Aspect 1: A method of wireless communication performed by a user equipment (UE), comprising: transmitting an indication of support for selectively using transmission diversity for communicating; and transmitting one or more communications selectively using transmission diversity.

Aspect 2: The method of Aspect 1, further comprising: receiving an indication to use transmission diversity for transmitting the one or more communications.

Aspect 3: The method of any of Aspects 1-2, further comprising: transmitting an indication that the UE is configured to transmit the one or more communications using transmission diversity.

Aspect 4: The method of any of Aspects 1-3, wherein the indication of support for selectively using transmission diversity for communicating includes an indication of support for selectively using a single transmission chain for communicating.

Aspect 5: The method of any of Aspects 1-4, wherein transmitting the one or more communications selectively using transmission diversity comprises: transmitting a first subset of the one or more communications using transmission diversity, and transmitting a second subset of the one or more communications using a single transmission chain.

Aspect 6: The method of any of Aspects 1-5, wherein the indication of support for selectively using transmission diversity for communicating indicates that the UE is capable of providing a threshold power amplification via a single power amplifier and is capable of providing the threshold power amplification via multiple power amplifiers using transmission diversity.

Aspect 7: The method of any of Aspects 1-6, further comprising transmitting an indication of support for one or more of: zero-delay transmission diversity, linear delay transmission diversity, or cyclic delay transmission diversity.

Aspect 8: The method of any of Aspects 1-7, further comprising transmitting an indication of one or more of: whether the UE supports transmission diversity delay that is a constant delay, or whether the UE supports transmission diversity delay that is a variable delay.

Aspect 9: The method of any of Aspects 1-8, further comprising transmitting an indication of one or more parameters of using transmission diversity delay, the one or more parameters comprising one or more of: a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

Aspect 10: The method of any of Aspects 1-9, further comprising receiving an indication to use, for the one or more communications, one or more of: a transmission diversity delay that is a constant delay, or a transmission diversity delay that is a variable delay.

Aspect 11: The method of any of Aspects 1-10, further comprising receiving an indication of one or more parameters for using a transmission diversity delay, the one or more parameters comprising one or more of: a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

Aspect 12: A method of wireless communication performed by a network node, comprising: receiving, from a user equipment (UE), an indication of support for selectively using transmission diversity for communicating; and receiving, from the UE, one or more communications selectively using transmission diversity.

Aspect 13: The method of Aspect 12, further comprising: transmitting an indication to use transmission diversity for transmitting the one or more communications.

Aspect 14: The method of any of Aspects 12-13, further comprising: receiving an indication that the UE is configured to transmit the one or more communications using transmission diversity.

Aspect 15: The method of any of Aspects 12-14, wherein the indication of support for selectively using transmission diversity for communicating includes an indication of support for selectively using a single transmission chain for communicating.

Aspect 16: The method of any of Aspects 12-15, wherein receiving the one or more communications selectively using transmission diversity comprises: receiving a first subset of the one or more communications using transmission diversity, and receiving a second subset of the one or more communications using a single transmission chain.

Aspect 17: The method of any of Aspects 12-16, wherein the indication of support for selectively using transmission diversity for communicating indicates that the UE is capable of providing a threshold power amplification via a single power amplifier and is capable of providing the threshold power amplification via multiple power amplifiers using transmission diversity.

Aspect 18: The method of any of Aspects 12-17, further comprising receiving an indication of support for one or more of: zero-delay transmission diversity, linear delay transmission diversity, or cyclic delay transmission diversity.

Aspect 19: The method of any of Aspects 12-18, further comprising receiving an indication of one or more of: whether the UE supports transmission diversity delay that is a constant delay, or whether the UE supports transmission diversity delay that is a variable delay.

Aspect 20: The method of any of Aspects 12-19, further comprising receiving an indication of one or more parameters of using transmission diversity delay, the one or more parameters comprising one or more of: a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

Aspect 21: The method of any of Aspects 12-20, further comprising transmitting an indication to use, for the one or more communications, one or more of: a transmission diversity delay that is a constant delay, or a transmission diversity delay that is a variable delay.

Aspect 22: The method of any of Aspects 12-21, further comprising transmitting an indication of one or more parameters for using a transmission diversity delay, the one or more parameters comprising one or more of: a mapping of one or more indicated transmission diversity delays to one or more allocations, a mapping of one or more indicated transmission diversity delays to one or more bandwidth parts, or a mapping of one or more indicated transmission diversity delays to one or more channel bandwidth sizes.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit an indication of support for selectively using transmission diversity for communicating; and
transmit one or more communications selectively using transmission diversity.

2. The UE of claim 1, wherein the one or more processors are further configured to:
receive an indication to use transmission diversity for transmitting the one or more communications.

3. The UE of claim 1, wherein the one or more processors are further configured to:
transmit an indication that the UE is configured to transmit the one or more communications using transmission diversity.

4. The UE of claim 1, wherein the indication of support for selectively using transmission diversity for communicating includes an indication of support for selectively using a single transmission chain for communicating.

5. The UE of claim 1, wherein the one or more processors, to transmit the one or more communications selectively using transmission diversity, are configured to:
transmit a first subset of the one or more communications using transmission diversity, and
transmit a second subset of the one or more communications using a single transmission chain.

6. The UE of claim 1, wherein the indication of support for selectively using transmission diversity for communicating indicates that the UE is capable of providing a threshold power amplification via a single power amplifier and is capable of providing the threshold power amplification via multiple power amplifiers using transmission diversity.

7. The UE of claim 1, wherein the one or more processors are further configured to transmit an indication of support for one or more of:
zero-delay transmission diversity,
linear delay transmission diversity, or
cyclic delay transmission diversity.

8. The UE of claim 1, wherein the one or more processors are further configured to transmit an indication of one or more of:
whether the UE supports transmission diversity delay that is a constant delay, or
whether the UE supports transmission diversity delay that is a variable delay.

9. The UE of claim 1, wherein the one or more processors are further configured to transmit an indication of one or more parameters of using transmission diversity delay, the one or more parameters comprising one or more of:
a mapping of one or more indicated transmission diversity delays to one or more allocations,
a mapping of one or more indicated transmission diversity delays to one or more bandwidth parts, or
a mapping of one or more indicated transmission diversity delays to one or more channel bandwidth sizes.

10. The UE of claim 1, wherein the one or more processors are further configured to receive an indication to use, for the one or more communications, one or more of:
a transmission diversity delay that is a constant delay, or
a transmission diversity delay that is a variable delay.

11. The UE of claim 1, wherein the one or more processors are further configured to receive an indication of one or more parameters for using a transmission diversity delay, the one or more parameters comprising one or more of:
a mapping of one or more indicated transmission diversity delays to one or more allocations,
a mapping of one or more indicated transmission diversity delays to one or more bandwidth parts, or
a mapping of one or more indicated transmission diversity delays to one or more channel bandwidth sizes.

12. A network node for wireless communication, comprising:
a memory; and
one or more processors, coupled to the memory, configured to:
receive, from a user equipment (UE), an indication of support for selectively using transmission diversity for communicating; and
receive, from the UE, one or more communications selectively using transmission diversity.

13. The network node of claim 12, wherein the one or more processors are further configured to:
transmit an indication to use transmission diversity for transmitting the one or more communications.

14. The network node of claim 12, wherein the one or more processors are further configured to:
receive an indication that the UE is configured to transmit the one or more communications using transmission diversity.

15. The network node of claim 12, wherein the indication of support for selectively using transmission diversity for communicating includes an indication of support for selectively using a single transmission chain for communicating.

16. The network node of claim 12, wherein the one or more processors, to receive the one or more communications selectively using transmission diversity, are configured to:
receive a first subset of the one or more communications using transmission diversity, and
receive a second subset of the one or more communications using a single transmission chain.

17. The network node of claim 12, wherein the indication of support for selectively using transmission diversity for communicating indicates that the UE is capable of providing a threshold power amplification via a single power amplifier and is capable of providing the threshold power amplification via multiple power amplifiers using transmission diversity.

18. The network node of claim 12, wherein the one or more processors are further configured to receive an indication of support for one or more of:
zero-delay transmission diversity,
linear delay transmission diversity, or
cyclic delay transmission diversity.

19. The network node of claim 12, wherein the one or more processors are further configured to receive an indication of one or more of:
whether the UE supports transmission diversity delay that is a constant delay, or
whether the UE supports transmission diversity delay that is a variable delay.

20. The network node of claim 12, wherein the one or more processors are further configured to receive an indication of one or more parameters of using transmission diversity delay, the one or more parameters comprising one or more of:
a mapping of one or more indicated transmission diversity delays to one or more allocations,
a mapping of one or more indicated transmission diversity delays to one or more bandwidth parts, or
a mapping of one or more indicated transmission diversity delays to one or more channel bandwidth sizes.

21. The network node of claim 12, wherein the one or more processors are further configured to transmit an indication to use, for the one or more communications, one or more of:
a transmission diversity delay that is a constant delay, or
a transmission diversity delay that is a variable delay.

22. The network node of claim 12, wherein the one or more processors are further configured to transmit an indication of one or more parameters for using a transmission diversity delay, the one or more parameters comprising one or more of:
a mapping of one or more indicated transmission diversity delays to one or more allocations,
a mapping of one or more indicated transmission diversity delays to one or more bandwidth parts, or
a mapping of one or more indicated transmission diversity delays to one or more channel bandwidth sizes.

23. A method of wireless communication performed by a user equipment (UE), comprising:
transmitting an indication of support for selectively using transmission diversity for communicating; and
transmitting one or more communications selectively using transmission diversity.

24. The method of claim 23, further comprising:
receiving an indication to use transmission diversity for transmitting the one or more communications.

25. The method of claim 23, further comprising:
transmitting an indication that the UE is configured to transmit the one or more communications using transmission diversity.

26. The method of claim 23, wherein transmitting the one or more communications selectively using transmission diversity comprises:
transmitting a first subset of the one or more communications using transmission diversity, and
transmitting a second subset of the one or more communications using a single transmission chain.

27. A method of wireless communication performed by a network node, comprising:
receiving, from a user equipment (UE), an indication of support for selectively using transmission diversity for communicating; and
receiving, from the UE, one or more communications selectively using transmission diversity.

28. The method of claim 27, further comprising:
transmitting an indication to use transmission diversity for transmitting the one or more communications.

29. The method of claim 27, further comprising:
receiving an indication that the UE is configured to transmit the one or more communications using transmission diversity.

30. The method of claim 27, wherein receiving the one or more communications selectively using transmission diversity comprises:
receiving a first subset of the one or more communications using transmission diversity, and
receiving a second subset of the one or more communications using a single transmission chain.
